(19) United States
(12) Patent Application Publication
(10) Pub. No.: US 2009/0324063 A1
(43) Pub. Date: Dec. 31, 2009

(54) IMAGE PROCESSING METHOD AND APPARATUS FOR CORRECTING SPECIFIC PART

(75) Inventors: Takeshi Murase, Yokohama-shi (JP); Masao Kato, Kawasaki-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/488,142

(22) Filed: Jun. 19, 2009

(30) Foreign Application Priority Data
Jun. 25, 2008 (JP) 2008-166253

(51) Int. Cl. G06K 9/00; G06K 9/46

(52) U.S. Cl. 382/163; 382/233

(57) ABSTRACT

An image processing method and an image processing apparatus capable of correcting with high efficiency a specific part are provided. According to one embodiment of the present invention, an original photographed image file is acquired. If face region information is added to the original photographed image file, this face region information is acquired. Subsequently, a first decoding region is determined based on the acquired face region information, and the first decoding region is decoded to the original photographed image file to generate first decoded image data. Subsequently, a red-eye region is detected from the generated first decoded image data, and specific part position information about a position of this red-eye region is acquired. Subsequently, the original photographed image file is decoded to generate second decoded image data, and a red-eye is corrected for the second decoded image data, based on the acquired specific part position information.

### BACKGROUND OF THE INVENTION

1. Field of the Invention

The present invention relates to an image processing method for performing object detection processing on an original photographed image file and performing image correction in accordance with a detection result, and relates to an image processing apparatus with an image correction function capable of implementing this image processing method. The present invention particularly relates to a technique of red-eye region detection and correction.

2. Description of the Related Art

When a person or the like is photographed with a digital camera, if a photograph is taken by using a flash in the dark room, for example, an effect in which the person's eye is photographed as red (red-eye) may happen. The red-eye effect is an effect in which the open pupil is photographed as red when a photograph of a person is taken under the dark environment. The cause of the red-eye effect is that light of the flash reflects off the blood vessels or the like in the eyeball of the photographic subject and returns to the camera.

The red-eye effect can be avoided to some extent by shifting the timing of emitting flash light during photographing. However, there have been problems that special mechanisms are required on the camera in order to realize such flash control, and that natural expressions of a photographic subject may change by emitting flash light in advance. Therefore, it has become more important to propose a technique which detects a red-eye part as a specific part from the image in which the red-eye effect is observed, and corrects the red eye to its natural pupil color, rather than a technique which prevents the red eye from occurring by improving photographing equipment.

As such a general method, there is a technique which detects a red-eye part as a specific part from the whole image file (photographed image file) obtained by photographing, and thereafter, corrects the detected red-eye part to its natural color. However, there has been a problem that detection failures occur easily so that the accuracy is poor.

In order to solve the problem, the following technique is disclosed: decoding processing is performed on a photographed image file and then detection processing of a face region (a first specific part) of a person is performed on the decoded image data; and successively detection of a red-eye as a second specific part is performed on the detected face region on the basis of the amount of characteristic, thereby improving the accuracy of detecting a red-eye region; and finally correction of the red eye is performed. (See, Japanese Patent Laid-Open No. 2003-30667).

Meanwhile, Japanese Patent Laid-Open No. 2007-004455 discloses a technique in which a photographed image file is decoded to generate image data, and then reduction processing is performed on the image data. Also disclosed is a technique in which face region detection and specific part detection are performed on the reduced image data to improve the speed of processing.

Further, Japanese Patent Laid-Open No. 2006-167917 discloses a technique that restricts an image region on which decoding processing is performed when an optimal layout is arranged depending on a photographed image, in order to reduce calculation processing load.

However, in the above invention described in Japanese Patent Laid-Open No. 2003-30667, red-eye region detection processing is performed after decoding processing and face region detection processing are performed on all the regions of image data. Accordingly, the calculation amount relatively increases. Especially, the number of pixels of image data obtained by photographing (photographed image data) is increasing due to development of high resolution with the improved performance of photographing equipment in recent years. Hence, there is a possibility that the calculation amount of image processing may increase.

As a result, calculation of image processing takes time in the environment of low-cost PCs and embedded devices which do not have sufficient hard resource such as CPU with high processing performance, or a large amount of memory. Therefore, subsequent printing processing or the like cannot be performed smoothly, and there is a possibility that a comfortable printing environment cannot be provided to a user.

With above invention described in Japanese Patent Laid-Open No. 2007-004455, since image processing such as face region detection and specific part detection generally has processing load larger than the reduction processing, it is possible to reduce the load of the whole image processing. Therefore, the above technique of the invention is a very useful technique, considering the viewpoint of improving the processing speed.

However, since the face region detection and the specific part detection are performed on the data obtained by reducing all the regions of the image data, information may be lost when the reduced data is created. Accordingly, the accuracy of the face region detection and the specific part detection may be lowered. As a result, the image may not be corrected sufficiently in exchange for the improvement in the speed.

Further, with above invention described in Japanese Patent Laid-Open No. 2006-167917, the load of image processing can be reduced. However, the invention aims to reduce the load of decoding processing. The Japanese Patent Laid-Open No. 2006-167917 aims to favorably lay out image data, with ease and low cost, in a manner that each of the image data is directed in the same direction, when multiple pieces of image data are assigned on a recording medium. Detection processing and correction processing on the decoded image data is not indicated clearly. That is, methods for performing desired detection processing are not disclosed at all.

Efficient correction has been desired to be performed on specific parts included in image data acquired with equipment such as a digital camera or a scanner which optically acquires images, or included in image data inputted from portable media such as CDs and a memory card, or PCs. Specifically, correction with high efficiency and high accuracy has been proposed to the specific parts (for example, eyes, a nose, a mouth, a skin, and a contour) in the image data of the above-described object to be corrected.

### SUMMARY OF THE INVENTION

The present invention provides an image processing method and an image processing apparatus capable of correcting a specific part included in the inputted image file or image data with high efficiency.

In order to attain such an object, according to an aspect of the present invention, an image processing method includes the steps of: acquiring image data; acquiring specific part information about a position of one region, including at least a specific part, of the acquired image data when the specific part information is added to the image data; determining a decoding region to be decoded based on the acquired specific part information in order to detect the specific part in the image data; generating first decoded image data by decoding the decoding region in the image data; acquiring specific part position information about a position of the specific part by detecting the specific part from the generated first decoded image data; generating second decoded image data by decoding the image data acquired at the acquiring step; and correcting the specific part of the second decoded image data based on the acquired specific part position information.

According to another aspect of the present invention, an image processing apparatus includes: unit for acquiring image data; unit for acquiring specific part information about a position of one region, including at least a specific part, of the acquired image data when the specific part information is added to the image data; unit for determining a decoding region to be decoded based on the acquired specific part information in order to detect the specific part in the image data; unit for generating first decoded image data by decoding the decoding region in the image data; unit for acquiring specific part position information about a position of the specific part by detecting the specific part from the generated first decoded image data; unit for generating second decoded image data by decoding the image data acquired by the unit for acquiring image data; and unit for correcting the specific part of the second decoded image data based on the acquired specific part position information.

With the present invention, an image processing method and an image processing apparatus capable of correcting a specific part included in the inputted image file or image data with high efficiency can be provided.

Further features of the present invention will become apparent from the following description of exemplary embodiments (with reference to the attached drawings).

### BRIEF DESCRIPTION OF THE DRAWINGS

FIG. 1 is a block diagram showing an example of a configuration of a computer (image processing apparatus) which performs image processing according to a first embodiment of the present invention;

FIG. 2 is a flow chart explaining overall processing of red-eye region detection, correction, and printing according to the first embodiment of the present invention;

FIG. 3 is a flow chart of the processing of the red-eye region detection and the correction according to the first embodiment of the present invention;

FIG. 4 is a view showing a positional relation in coordinates between photographed image data and face region information, stored in an original photographed image file, according to the first embodiment of the present invention;

FIG. 5 is a view showing a positional relation in coordinates between a face region and a rectangular region described in Exif Tag according to the first embodiment of the present invention;

FIG. 6 is a flowchart of processing of red-eye region detection and correction according to a second embodiment of the present invention;

FIG. 7 is a view showing a positional relation in coordinates between original photographed image data and multiple pieces of face region information according to the second embodiment of the present invention;

FIG. 8 is a schematic diagram which unifies multiple pieces of decoded image data of face regions to one piece of decoded image data according to the second embodiment of the present invention;

FIG. 9 is a flow chart of processing of red-eye region detection and correction according to a third embodiment of the present invention;

FIG. 10 is a view explaining coordinate information and skew information of a face region according to the third of the present invention; and

FIG. 11 is a flow chart of processing of red-eye region detection and correction when eye region information is attached to information relating to a photographed image file according to a fourth embodiment of the present invention.

### DESCRIPTION OF THE EMBODIMENTS

Embodiments of the present invention will be explained below in detail with reference to drawings. In the drawings described below, components having the same functions are denoted by the same numerals, and the explanation thereof is omitted.

The present invention provides a specific part detection processing method with high speed and high accuracy to an image file or image data having added thereto information (specific part information) about specific parts, such as face region information, for example. In addition, the present invention provides a specific part detection processing method also to an image file or image data having added thereto no specific part information.

The present invention provides a specific part detection processing method with high speed and high accuracy, even when there are multiple specific parts (for example, face regions) in a piece of a photographed image, when the specific part is skewed, and when there are multiple specific parts which are skewed.

Further, the present invention provides an apparatus which performs specific part detection processing with high speed and high accuracy, correction, and printing.

According to an embodiment of the present invention, the following configuration is provided. That is, an image processing apparatus according to the embodiment of the present invention is provided with an image input unit, a specific part information analysis unit, a decoding unit, a specific part detection unit, and a correction processing unit.

The above-described image input unit inputs image data into the above-described image processing apparatus, that is, the image processing apparatus acquires image data. Therefore, predetermined image data can be inputted into the image processing apparatus via the image input unit from apparatuses which acquire image data optically, such as digital cameras and scanners. Moreover, image data can be inputted via the image input unit also from portable media, such as magnetic disks, optical discs, and memory cards. Image data inputted via the image input unit may be inputted in a form included in an image file. That is, the image processing apparatus can also acquire an image file via the image input unit.

The above-described specific part information analysis unit determines whether or not specific part information (for example, face region information) is added to (attached to) image data received in the above-described image input unit. If the specific part information analysis unit determines that specific part information is added to the image data, the specific part information is acquired from the above-described image data.

Note that, a “specific part” in the description refers to a region to be corrected on image data, in a photographic subject of a human being, for example. Therefore, a specific part serves as “eyes” for performing red-eye correction, for example, and serves as “skin” for performing whitening correction.

Note that, “specific part information” is position information for specifying one region of the image data (for example, a face region) including at least the above-described specific part. Therefore, the specific part information includes position information (for example, face region information) for specifying a predetermined region (for example, a face region) including a specific part and position information which shows the specific part itself (for example, eye region information).

The above-described face region information is position information for specifying a region of a face in the image data. The above-described eye region information is information in the image data which shows the specific part itself, and is position information for specifying regions of eyes.

If specific part information is added to the inputted image data, the specific part information analysis unit analyzes the specific part information, and specifies one region of the image data (for example, a face region) including at least the above-described specific part. With respect to the region specified in this manner, decoding for specific part detection, which is described later, is performed. If a determination is made that specific part information is not added to the image data, the specific part information analysis unit can decide all the regions of the image data as a region which performs decoding for specific part detection (a first decoding region). Thus, the specific part information analysis unit can decide a first decoding region based on the specific part information.

If specific part information is added to the image data, the above-described decoding unit decodes on one region of image data including at least the above-described specific part among the inputted image data as the first decoding region (first decoding processing).

Thus, according to one embodiment of the present invention, if specific part information, such as face region information and eye region information, is added to the inputted image data, the specific part information is analyzed and a position thereof is specified. After that, a region where decoding processing is performed based on the position information (a first decoding region) is decided, and decoding processing is performed only to the first decoding region in the image data.

The specific part detection unit detects a specific part based on the amount of characteristic of the specific part from image data after the first decoding (also referred to as “first decoded image data”) acquired by the first decoding processing. Thus, the specific part detection processing is performed. That is, the specific part detection unit detects the specific part from the first decoded image data, and acquires position information on the detected specific part (specific part position information).

At this time, the specific part detection processing is performed on data obtained by decoding one region of the image data including at least the specific part (first decoded image data) as mentioned above, instead of the whole image data. Therefore, time and a memory capacity necessary for the processing of acquiring the specific part position information can be reduced. Accordingly, efficient correction processing of the specific part can be achieved.

Subsequently, the decoding unit decodes the above-described inputted image data (second decoding processing), and acquires image data after the second decoding (also referred to as “second decoded image data”). A region where the decoding is performed (second decoding region) is the whole image data.

Note that, “decoded image data” in the description refers to image data obtained by decoding certain encoded image data or by decoding compressed data.

The correction processing unit corrects the specific part based on the above-described acquired specific part position information in the above-described acquired second decoded image data.

The above-described specific part detection processing (image processing method) is incorporated into a printing device, such as a printer, so that printing can be performed after correcting the detected specific part.

### First Embodiment

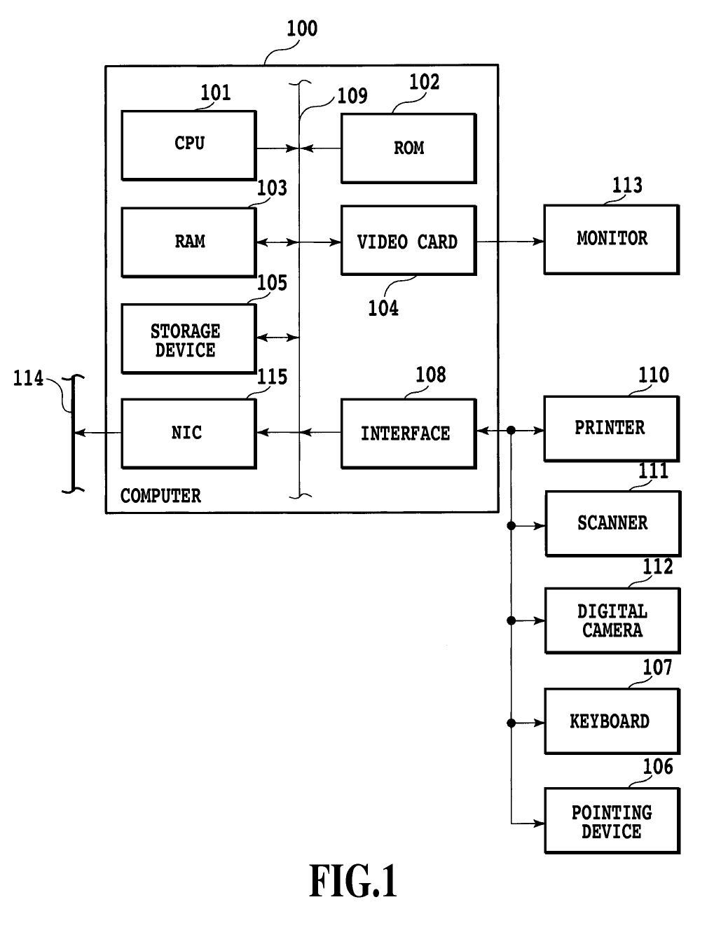

FIG. 1 is a block diagram showing an example of a configuration of a computer (image processing apparatus) performing image processing, which implements this embodiment.

A computer 100 is provided with a CPU 101, a ROM 102, a RAM 103, and a video card 104 which connects with a monitor 113 (a touch panel can be included) Furthermore, the computer 100 is provided with a storage device 105, such as a hard disk drive and a memory card, as a storage region. The computer 100 is provided with an interface 108 for serial buses, such as USB and IEEE1394, which connect with a pointing device 106, such as a mouse, a stylus, and a tablet, a keyboard 107, and the like. The computer 100 is further provided with a network interface card (NIC) 115 which connect to a network 114. These configurations are mutually connected via a system bus 109. The interface 108 can be connected with a printer 110, a scanner 111, a digital camera 112, or the like.

The CPU 101 loads a program (including an image processing program which will be explained below) stored in the ROM 102 or the storage device 105 into the RAM 103 which is a work memory, and executes the program. Subsequently, the function of the program is implemented by controlling each of the above-described configurations via the system bus 109 in accordance with the program.

FIG. 1 shows a general configuration of hardware which performs image processing described in this embodiment. If a part of the configuration is lacked or other devices are added, the configuration is included in the category of the present invention.

Red-eye correction processing is described below as an example. Accordingly, a specific part to be corrected is a red eye. “One region of image data including at least a specific part” is a face region. Hereinafter, described is a form in which an image file subjected to predetermined compression and coding is acquired from the digital camera 112 or the film scanner 111, and image data stored in the image file is corrected. Note that, it is needless to say that data to be corrected may be image data subjected to predetermined compression and coding, not a form of an image file.

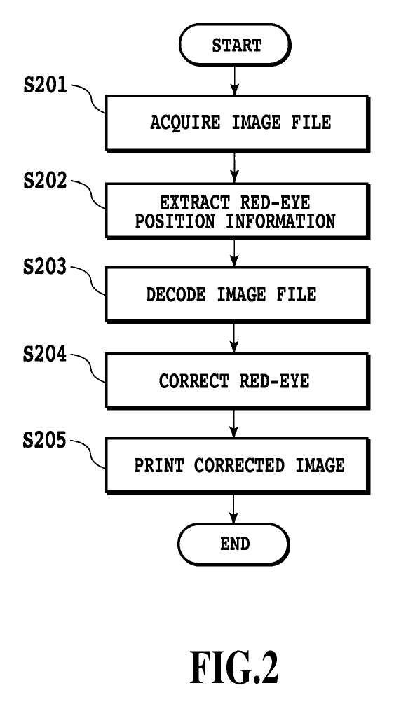

FIG. 2 is a chart of an overall processing flow when performing red-eye correction processing of an image file and printing the image in this embodiment.

This processing flow is processing executed by the CPU 101, for example. Therefore, the processing is controlled as follows: the CPU 101 reads out a program to perform processing shown in FIG. 2, stored in the ROM 102 or the storage device 105, and executes the program.

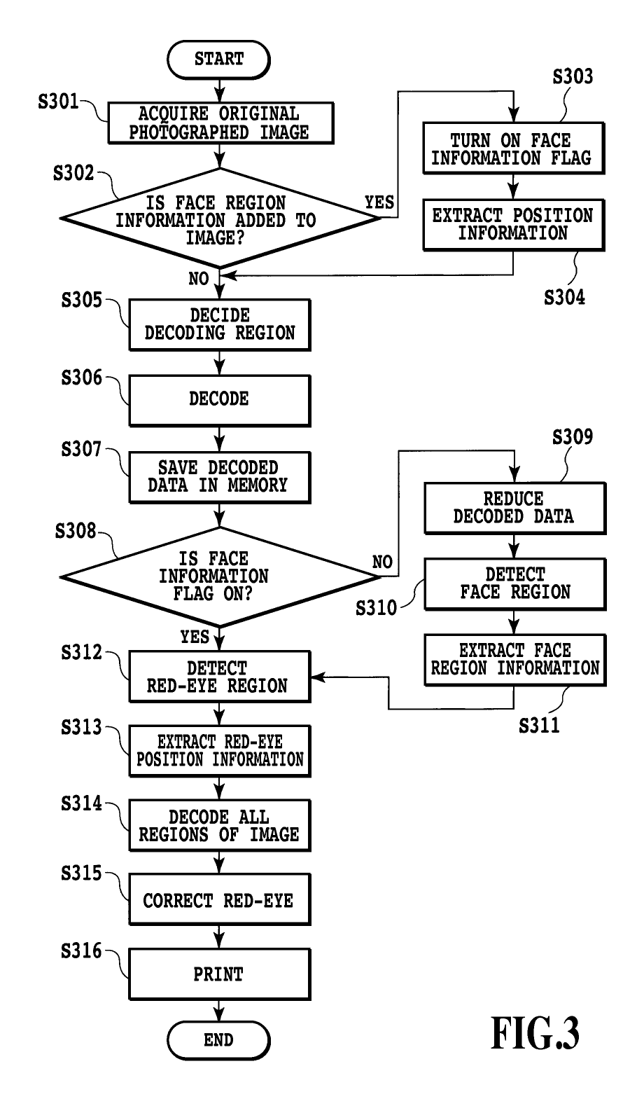

An inputted image is digital image data of 8-bit RGB per pixel, a total of 24 bits, which is inputted from the digital camera 112 or the film scanner 111, for example. The detailed explanation is described later with FIG. 3, and is omitted here.

Hereinafter, the computer 100 as an image processing apparatus acquires an image file (original photographed image file) including image data (photographed image data) obtained by photographing with the digital camera 112.

At S201, an image file which stores image data therein and information relating to the image data (specific part information) are acquired from the digital camera 112, and information on a face region is extracted from the information relating to the image data. In FIG. 2, since one region of image data including at least a specific part is a face region, the above-described specific part information is face region information.

At S202, red-eye position information as specific part position information is extracted to the image file acquired at S201. Means which decodes an image file when a red-eye region is detected (first decoding processing) is referred to as a first decoding unit (not shown), and the decoded image data thus generated is referred to as a first decoded image data. Here, decoding processing in this embodiment means to convert the compressed image data into the non-compressed image data. For example, a YCbCr space, which is a color space of JPEG, is converted into an RGB space or a YCC space. Other color spaces also may be used.

At S203, decoding processing to all the regions of the image (second decoding processing) is performed on the image file acquired at S201. Means which performs decoding processing to all the regions of the image file is referred to as a second decoding unit (not shown), and the decoded image data thus generated is referred to as a second decoded image data.

At S204, red-eyes are corrected in the image data decoded at S203 (second decoded image data), based on the red-eye position information extracted at S202.

At S205, the image is printed based on the image data in which the red-eyes are corrected at S204.

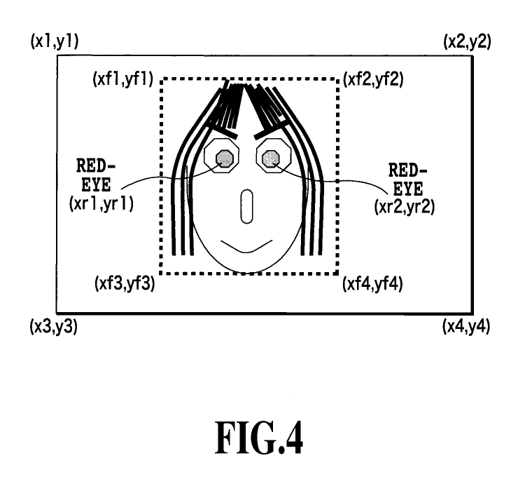

Next, a main feature of this embodiment will be explained with FIGS. 3 and 4.

FIG. 3 is a processing flow chart showing details when red-eye correction processing is performed on photographed image data, which is an original image, and the image is printed in this embodiment.

The detailed explanation about S201 and S202 in FIG. 2 is given in S301 to S313, and the detailed explanation about S203, S204, and S205 is given in S314 to S316.

Here, a case where one piece of face region information is included in one image is described. A more effective embodiment in a case where multiple pieces of face region information are included will be explained in a second embodiment described later. A more effective embodiment in a case where a face region in photographed image data is skewed will be explained in a third embodiment described later. A more effective example of a case where information other than the face region information, eye information for example, is included is explained in a fourth embodiment described later.

In this embodiment, described is a system in which image processing is performed with a PC as an image processing apparatus that executes an image processing method characteristic to the present invention, and in which printing is performed with a printer. However, not limited to this system, the same effect can be obtained if this embodiment is applied to a system in which the above-described image processing method is included in a body of an image forming device, such as a printer, for example, image processing and correction characteristic to the present invention are performed, and in which printing is performed. Therefore, it is needless to say that this embodiment is not limited to the processing form with a PC. This also applies to other embodiments.

Although this embodiment explains about a case which aims at creating a “printed matter” finally, the last form at which the present invention aims is not limited to the “printed matter”. In addition to the “printed matter”, an image for “displaying” a corrected image on a display device, such as a display, may be generated, or image data for filing a corrected image to re-store the file may be generated. A main object of the present invention relates to a method of forming a corrected image. This also applies to other embodiments.

This embodiment describes an embodiment of an image file recorded with a digital camera. However, the same effect can be obtained with an image file (or image data) recorded with devices, such as a scanner, other than digital cameras. Moreover, the same effect as this embodiment can be obtained in image data and image files stored in portable media, such as a magnetic disk, an optical disc, and a memory card. Therefore, it is needless to say that image data or an image file to be corrected in the present invention is not limited to an image file recorded with a digital camera.

Hereafter, details of processing are described based on FIG. 3. The processing is controlled as follows: the CPU 101 reads out a program to perform processing shown in FIG. 3, stored in the ROM 102 or the storage device 105, and executes the program.

At S301, an original photographed image file stored in a memory card 105 with the digital camera 112 in FIG. 1 is acquired. That is, the CPU 101 performs control to acquire an original photographed image file from the digital camera 112 via the interface 108 which functions as an image input unit. When this digital camera 112 has a face detection function, the digital camera 112 can detect a face region from the photographed image data, and can attach face region information as specific part information to the original photographed image file.

Hereinafter, an image file inputted into the computer 100 from the digital camera 112 is referred to as an original photographed image file.

In this embodiment, an embodiment is described supposing an image format of JPEG, which is a compression coding international-standard system of a still image. That is, the explanation is made that the above-described original photographed image file is a JPEG file. However, in addition to the JPEG file, the same effect can be obtained on data saved in a data format, such as bmp or tiff, which is a general file format of image data. Thus, it is needless to say that this embodiment is not limited to a JPEG file format.

Coding of JPEG will be explained below. Decoding is processing which decodes coded data.

In an image compression coding system of JPEG, coding is simply performed by the following processing procedure:
(1) Color separate image information into a brightness component and a color difference component;
(2) Break into predetermined pixel blocks for every color component;
(3) Orthogonal transform (DCT: discrete cosine transform) within the block;
(4) Quantize a DCT coefficient in a quantization step which fitted to vision characteristics;
(5) Rearrange an AC quantization coefficient into a one-dimensional array based on the regularity of a zigzag scan from a low frequency area to a high frequency area;
(6) Two-dimensional Huffman coding of the continuous run numbers with coefficient zero, and a significant coefficient of non-zero appeared after the coefficient zero; and
(7) DPCM coding of a DC quantization coefficient with a proximity block.

In the quantization process of a DCT coefficient corresponding to (4) and (7) described above, degradation arises in image information, and the data after compression coding cannot be perfectly restored to the original image information. A degree of degradation originates in the compression ratio. There are many digital cameras which can specify several steps of compression ratios with an instruction by a user. In the quantization process, a rougher quantization step is set in the color difference component having lower sensitivity than in the brightness component having high sensitivity, so as to fit vision characteristics of a human being. Accordingly, the irreversibility of the color difference component becomes large as a result of quantization. The file size of an image file becomes small with a high compression ratio so that the number of image files which can be stored in a card memory or the like increases naturally.

Generally, an image file stores, in addition to image data, photographing conditions when the photograph is taken with the digital camera 112. The photographing conditions include various photographing information such as, for example, the pixel number of length/width, an exposure condition, presence of flashing strobe light, a condition of white balance, a photographing mode, and photographing time. Data of the photographing information includes an ID number corresponding to the photographing information, a data format, a data length, an offset value, and data specific to the photographing information.

Exif (Exchangeable Image Format) defined by JEIDA can be used as the format, for example.

*JEIDA: (Japan Electronic Industry Development Association)

This embodiment describes a case where face region information is stored in a part within Exif Tag information. That is, according to this embodiment, face region information as specific part information has a format based on an Exif format. However, the same effect can be achieved by implementing the present invention to a system in which face region information is stored with formats other than the Exif format, for example, a format in which face region information is embedded into image data. Thus, it is needless to say that this embodiment is not limited to a form in which face region information is stored in Exif Tag information.

At S302, a determination is made as to whether face region information is stored in Exif Tag to the original photographed image file acquired at S301. In this embodiment, the processing goes to S303 if a determination is made that face region information is stored, while the processing goes to S305 if a determination is made that face region information is not stored.

At S303, a face information flag turns ON. Flag information is saved in a PC memory region of the RAM 103.

At S304, position information of face region information in the original photographed image file is extracted. This embodiment shows a case where information of four points, (xf1, yf1) (xf2, yf2) (xf3, yf3), and (xf4, yf4), is described, when a face region is surrounded by a rectangle. The CPU 101 extracts coordinates of the four points based on the face region information.

FIG. 4 shows a relation between photographed image data and face region information stored in the original photographed image file in this embodiment. A point at the upper left of the photographed image data is set to (x1, y1), a point at the upper right thereof is (x2, y2), a point at the lower left thereof is (x3, y3), and a point at the lower right thereof is (x4, y4). A rectangular region surrounding the face region stored in Exif Tag is stored as coordinate information of an upper left point (xf1, yf1), a upper right point (xf2, yf2), a lower left point (xf3, yf3), and a lower right point (xf4, yf4). That is, in this case, the face region information is position information which shows the positions (xf1, yf1), (xf2, yf2), (xf3, yf3) and (xf4, yf4).

At S305, a region (first decoding region) to be decoded from the original photographed image file is decided. Here, when (xf1, yf1), (xf2, yf2), (xf3, yf3), and (xf4, yf4), which are position information on the face region (face region information) are extracted at S304, a decoding region is decided based on this information. According to this embodiment, face region information is attached to the original photographed image file if the face information flag is ON at S303. Thus, based on the face region information, a decoding region (first decoding region) for performing red-eye region detection processing can be made smaller than the whole image data. Therefore, if the above-described face information flag is ON, the CPU 101 decides the rectangular region specified by the face region information and surrounded by (xf1, yf1), (xf2, yf2), (xf3, yf3), and (xf4, yf4) as the first decoding region.

On the contrary, if position information on the face region is not extracted (if the face information flag is OFF), the rectangular region corresponding to all the regions of the original photographed image file and surrounded by (x1, y1), (x2, y2), (x3, y3), and (x4, y4) is decided as a first decoding region.

Face region information may be information on four points of a rectangle of a face region as in this embodiment, or may be center coordinates of a face region or graphic information of a polygon centering on center coordinates of a face region. Face region information may be position information on a specific part (such as a contour) of a face region. A region to be decoded at S305 can be decided based on the position information on the face region (face region information) extracted at S304, regardless of types of forms in which the face region information is stored.

A region (first decoding region) to be decoded at S305 may be a rectangular region surrounded by (xf1, yf1), (xf2, yf2), (xf3, yf3), and (xf4, yf4) as in this embodiment. The same region as the coordinate information (xf1, yf1), (xf2, yf2), (xf3, yf3), and (xf4, yf4), which is face region information, may not always be the first decoding region. For example, the same effect can be obtained with a region in which the above-described rectangular region is expanded or reduced by a predetermined pixel. That is, when at least a specific part to be detected is included, it is needless to say that the present invention is not limited to a form which decodes the rectangular region itself including the face region. When position information on a face region (face region information) is described by one center coordinate, polygon information, or the like, an arbitrary region centering on the center coordinate may be a first decoding region. As a result, the same effect as in this embodiment can be obtained. It is needless to say that the present invention is not limited to a system in which face region information is indicated by rectangular coordinate information. Details will be supplementarily explained in the embodiments described later.

Thus, according to this embodiment, when the face region information is attached to the original photographed image file, the image processing apparatus can recognize one region of the image data based on this face region information, before decoding. Here, the one region includes red-eyes, which are specific parts to be corrected. Therefore, this one region is set to the first decoding region so that decoding for red-eye detection (first decoding processing) can be performed on the image data smaller than the original photographed image file, without performing on the whole original photographed image file. That is, the face region information acquired with use of other devices (here, the digital camera 112) can be used effectively so that a first decoding region where an unnecessary region in the original photographed image file is excluded from a viewpoint of specifying a red-eye region can be decided. Therefore, increase in efficiency of red-eye correction processing can be attained.

At S306, the coordinate information of four points of the rectangular region selected at S305 is received. Here the four points are: (xf1, yf1) (xf2, yf2) (xf3, yf3), and (xf4, yf4); or (x1, y1), (x2, y2), (x3, y3), and (x4, y4). That is, the CPU 101 acquires the position information for specifying a position of the first decoding region (position information on the first decoding region) decided at S305. The first decoding processing is performed on the rectangular region surrounded by the four points by using the first decoding unit. Decoded image data generated here is a first decoded image data.

At S307, the first decoded image data generated at S306 is received, and is saved in a PC memory region of the RAM 103.

At S308, a determination is made as to whether or not the face information flag turns ON at S303 with reference to the PC memory region of the RAM 103. If the face information flag is ON, the processing goes to S312, while if OFF, the processing goes to S309.

At S309, reduction processing is performed on the first decoded image data saved in the PC memory region of the RAM 103. The reduced image is again saved in the PC memory region of the RAM 103.

As the reduction processing here, a wide variety of algorithm methods, such as nearest neighbor, bilinear, and bi-cubic, are applicable.

As a typical method to reduce images, algorithm methods of nearest neighbor, bilinear, and bi-cubic will be explained.

The nearest neighbor method is a method of simply using pixel data nearest to a target pixel to interpolate and converting resolution. That is, resolution conversion is possible at high speed by replacing pixel data of the target pixel with the nearest pixel data. The bilinear and bi-cubic methods are methods of mathematically calculating target pixel data from multiple pixel data in the vicinity of the target pixel, interpolating, and converting resolution. Especially, the bi-cubic method has high accuracy and is suitable for resolution conversion with excellent gradation. The bilinear and bi-cubic methods are widely used, because both of them obtain pixel data of a target pixel from 4 pixels or 16 pixels in the vicinity of the target pixel so that an image relatively close to an original image can be generated.

In this embodiment, any method may be used among the above-described methods. Any other methods, in addition to the above-described methods, may be used, not limited to the description above.

At S310, face region detection processing is performed on the first decoded image data reduced and saved in the PC memory region of the RAM 103 at S309.

At S311, the face region detected at S310 is surrounded by a rectangle, and coordinate information of four points, which are apexes of the rectangle, are extracted as (xf1, yf1), (xf2, yf2), (xf3, yf3), and (xf4, yf4). Accordingly, the four points thus acquired become face region information. Considering influence on image quality after correction, this embodiment describes a form in which correction processing is performed on the image data before reduction even when the red-eye region detection is performed on the reduced data. Therefore, for extracting a face region, the coordinates converted into coordinates in the first decoded image data before reduction are used.

Thus, according to this embodiment, when face region information is not attached to the original photographed image file, the CPU 101 sets the whole original photographed image file as the first decoding region, and performs the first decoding processing. Moreover, the CPU 101 detects a face region from the first decoded image data obtained by the first decoding processing. Here, a face region can be efficiently detected by reducing the first decoded image data before detecting the face region as in this embodiment.

At S312, detection processing of a red-eye region is performed on the first decoded image data saved in the PC memory region of the RAM 103. If face region information is stored in Exif Tag of the original photographed image file, red-eye region detection processing is performed on the first decoded image data having the points, (xf1, yf1) (xf2, yf2) (xf3, yf3), and (xf4, yf4), as apexes. If not stored, red-eye region detection processing is performed on the face region detected at S311 in the first decoded image data including all the regions of the image data.

At S313, position information on the red-eye region detected at S312 (specific part position information) is extracted as center coordinates of the red-eyes (xr1, yr1) and (xr2, yr2) According to this embodiment, although center coordinates of the red-eyes are extracted, information including the contour of the red-eyes can be extracted. When one red-eye is recognized, only (xr1, yr1) may be extracted. Considering influence on image quality after correction, this embodiment describes a form in which red-eye region detection is performed on the first decoded image data after reduction, and correction processing is performed on the decoded image data without reduction processing. Therefore, for extracting a red-eye region, the coordinates converted into coordinates in the first decoded image data before reduction are used.

At S314, decoding processing is performed on all the regions of the photographed image file using the second decoding unit (second decoding processing). Decoded image data generated here is referred to as a second decoded image data.

At S315, red-eye correction is performed on the second decoded image data generated at S314 based on (xr1, yr1) and (xr2, yr2), which are the center coordinates of the red-eyes (specific part position information) extracted at S313. The corrected image data is saved in the PC memory region of the RAM 103. Details of red-eye region detection and correction are disclosed in various documents and patent documents. Moreover, since the detecting method or correcting method is not the essence of the present invention, the explanation is omitted here.

At S316, the image data saved in the PC memory region of the RAM 103 is printed. Printing units (for example, an ink-jet printer or an electro-photographic printer) are disclosed in various documents and patent documents, the detailed explanation is omitted here.

Effects of this embodiment will be explained below.

As mentioned above, with the steps of S302, S303, S304, and S308, by using the face region information in the original photographed image file, a region including the face region necessary for performing red-eye region detection is decided from all the regions of the image, and partial decoding can be performed.

As a result, the calculation amount of image processing can be reduced by reducing the image data region to be decoded and simplifying face region detection processing, for the original photographed image file having added thereto face region information. Therefore, high-speed specific part detection, correction, and printing can be provided even in an environment with insufficient hard resource.

When face region information is attached to an original photographed image file acquired from other devices, image data in which only a face region is expanded, not image data in which the whole image data is reduced, is treated for specific part detection processing. When using a memory region of the same size, the image data in which only a face region is expanded is close to original data and has less information lack. When specific part detection processing (red-eye region detection processing) is performed subsequently, more improvement in detecting accuracy of a specific part can be expected by using the face region information in Exif Tag information. As a result, the probability of occurrence of a correction error can be reduced, and desired red-eye correction can be achieved.

Note that, it is needless to say that the same effect can be obtained even if data acquired from other devices, such as a digital camera and a scanner, is not only an image file such as an original photographed image file but image data.

In this embodiment, the processing of red-eye region detection and correction is described. However, this embodiment is applicable to detecting organs, such as eyes, a nose, a mouth, and a contour, or analyzing color data of skin in a face region or histogram information, for subsequent whitening correction, small face correction, expression estimation, or the like. In this case, a specific part may be set as required to eyes, a nose, a mouth, a contour, skin, or the like in accordance with a form of correction.

In this embodiment, decoding is performed by limiting to a region including the face region image data necessary for performing specific part detection from the image file or all the regions of the image data, and information loss is prevented by reducing the reduction processing. Thus, the same effects of increasing the accuracy and speed can be obtained. Therefore, it is needless to say that specific part detection processing provided by this embodiment is not limited to red-eyes.

In photographing equipment as other devices, such as a camera and a video, capable of using data of the time before the photographed image moment for detection processing, detection processing based on more information than that of in the system of this embodiment which treats a still image is available. Thus, the effect of more improvement in accuracy is attained.

When an image file or image data information has further added thereto other information such as information on a person name, in addition to the specific part information such as face region information, the same effects of increasing the accuracy and speed can be obtained even in processing of determining a person, for example, by using the information. Therefore, it is needless to say that this embodiment is applicable to a technical field, such as person determination.

In this embodiment, the case where the first decoding region is the rectangular region surrounded by (xf1, yf1), (xf2, yf2), (xf3, yf3), and (xf4, yf4), which is position information on the face region, and described in Exif Tag is described at S305. However, a rectangular region described in Exif Tag may be described with various forms. Thus, necessary image data on the specific part may not be included.

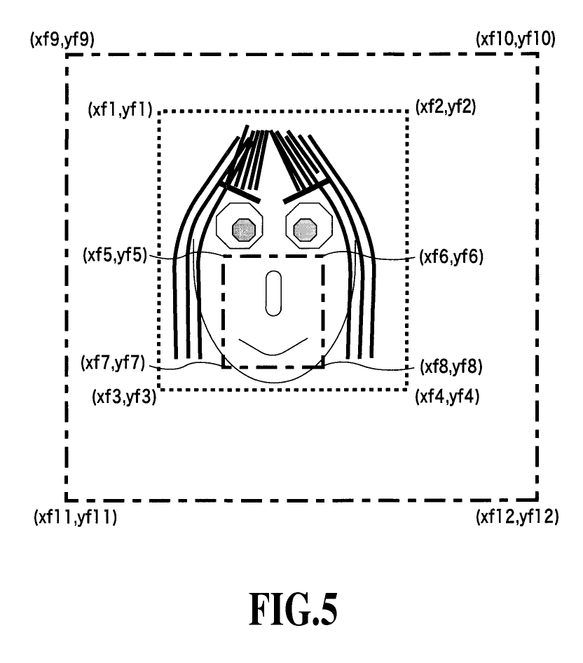

FIG. 5 indicates a relation between the face region and the rectangular region described in Exif Tag.

When the rectangular region described in Exif Tag includes the face region, such as (xf1, yf1), (xf2, yf2), (xf3, yf3), and (xf4, yf4), the rectangular region includes a specific part to be detected (for example, a red-eye region). As a result, red-eye region detection can be performed by using the rectangular region described in Exif Tag as a decoding region.

However, in a system which records a part of the face region on Exif Tag as a rectangular region such as (xf5, yf5), (xf6, yf6), (xf7, yf7), and (xf8, yf8), the rectangular region may not include a specific part to be detected (for example, a red-eye region). Therefore, it is necessary to perform decoding processing to a region obtained by expanding the region surrounded by (xf5, yf5), (xf6, yf6), (xf7, yf7), and (xf8, yf8).

Meanwhile, in a system which records a region obtained by expanding the face region on Exif Tag as a rectangular region such as (xf9, yf9), (xf10, yf10), (xf11, yf11), and (xf12, yf12), a region other than the face region may be decoded. As a result, it is more efficient to decode a region obtained by reducing the rectangular region.

Accordingly, although it is extremely important in the present invention how the rectangular region described in Exif Tag surrounds a face region, it is considered that a method of describing information may vary depending on DSC (Digital still camera). Therefore, in order to certainly include a specific part, a system which performs decoding processing to a region obtained by expanding the rectangular region based on rectangular region information (specific part information) described in Exif Tag is applied. Accordingly, specific part detection can be surely performed and correction can be sufficiently performed. As a result, as compared with prior art which performs decoding processing to all the regions of image data, the effects of increasing the accuracy and speed can be obtained. It is needless to say that the present invention is not limited to a form in which the rectangular region described in Exif Tag itself is decoded.

When position information on a face region (specific part information) is described by one center coordinate, polygon information, or the like, an arbitrary region may be selected by centering on the center coordinate. As a result, the same effect as this embodiment can be obtained. It is needless to say that this embodiment is not limited to a system in which face region information is described by rectangular coordinate information.

In this embodiment, image data and face region information described in Exif Tag information have been explained as an image file. In recent years, a printing system which connects DSC and a printer with a USB cable directly has been also provided. In such a case, there is no need that the image data and the face region information constitute one file. The image data and the face region information may exchange information between DSC and the printer individually. Therefore, it is needless to say that an object of the present invention can be achieved even in such a case.

A number of methods have been proposed as a method of detection of positions of a face and organs, and correction in this embodiment (for example, Japanese Patent Laid-Open No. 2003-30667). Any method among the above-described methods may be used in this embodiment. Any other methods may be used, not limited to the above-described methods. Details of detection of positions of a face and organs, and correction are disclosed in various documents and patent documents. Moreover, since the detection and correction are not the essence of the present invention, the explanation is omitted here.

### Second Embodiment

Next, a case where two or more face regions are included in one piece of image data and the above-described image data have added thereto multiple face region information will be explained. In a second embodiment, a more effective embodiment in a case where one piece of photographed image data includes multiple face regions and multiple pieces of face region position information is described in Exif Tag information will be described as an example.

The forms as shown in FIG. 1 and FIG. 2 in the first embodiment can also be applied here to a block diagram showing an example of a configuration of a computer (image processing apparatus) which performs image processing and a flow chart of overall processing of red-eye correction processing for an image file and printing of an image file, respectively. The detailed explanation is omitted here.

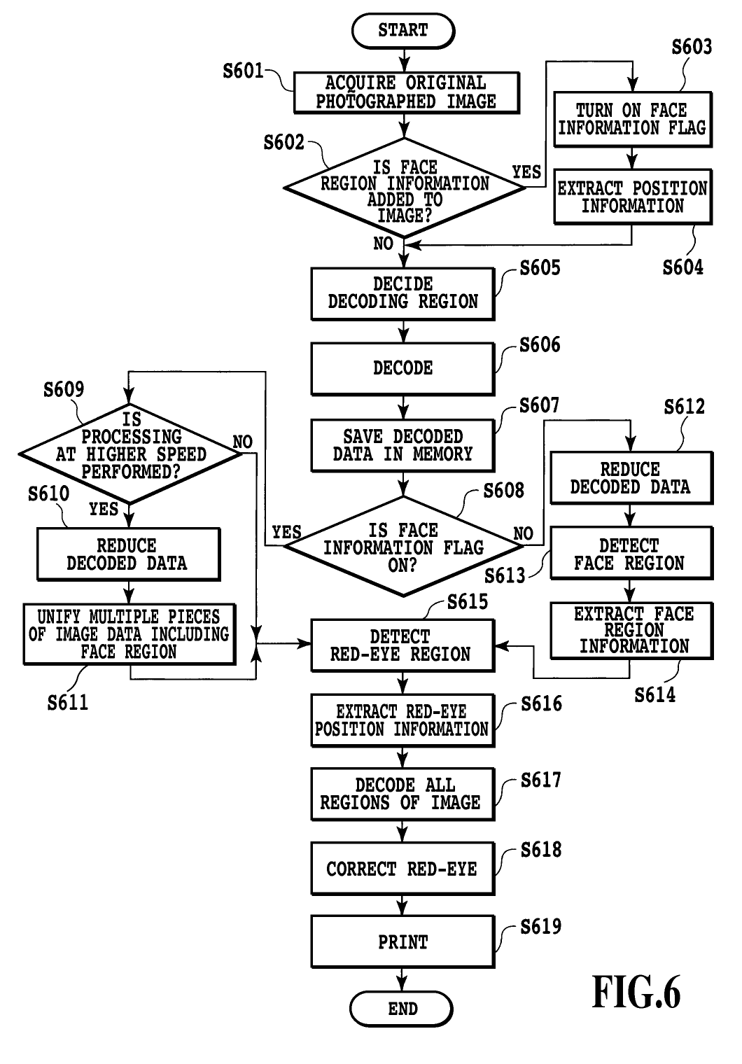

FIG. 6 is a processing flow chart showing details of red-eye region detection processing to the multiple face regions of this embodiment.

Hereafter, the details of processing are described based on FIG. 6. The processing is controlled as follows: the CPU 101 reads out a program to perform processing shown in FIG. 6, stored in the ROM 102 or the storage device 105, and executes the program.

The detailed explanation about S201 and S202 in FIG. 2 is given in S601 to S616, and the detailed explanation about S203, S204, and S205 is given in S617 to S619.

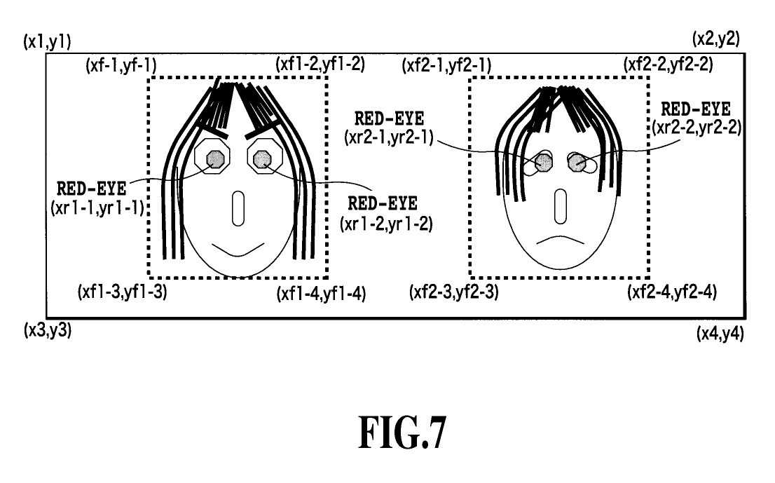

FIG. 7 shows a relation between image data and face region information in this embodiment.

In this embodiment, described is a case where two face regions are included in one piece of image data. However, the same effect can also be obtained in a case where three or more face regions are included in one image. Thus, it is needless to say that this embodiment is not to be limited to two face regions.

Since S601, S602, and S603 are the same as S301, S302, and S303 in the first embodiment, the detailed explanation is omitted here.

At S604, position information of face region information in the original photographed image file is extracted. According to this embodiment, it is assumed that two pieces of face region information are described in a coordinate format. In this embodiment, coordinate information of eight points, when two face regions are surrounded by two rectangles, is extracted. That is, a face region included in a rectangular region surrounded by (xf1-1, yf1-1), (xf1-2, yf1-2), (xf1-3, yf1-3), and (xf1-4, yf1-4), which is first face region information, is set as a face 1 in this embodiment. Further, a face region included in a rectangular region surrounded by (xf2-1, yf2-1), (xf2-2, yf2-2), (xf2-3, yf2-3), and (xf2-4, yf2-4), which is second face region information, is set as a face 2.

Face region information may be information on four points of a rectangle of a face region as in this embodiment, or may be center coordinates of a face region or graphic information of a polygon centering on center coordinates of a face region. Face region information may be position information on a specific part (such as a contour) of a face region.

At S605, a region subjected to a first decoding processing (first decoding region) is decided from the original photographed image file.

FIG. 7 shows a relation between face regions and coordinate information (face region information).

If coordinate information of eight points, which is position information on the face regions (face region information), is described at S604, the first decoding region is decided based on this information.

According to this embodiment, two rectangular regions of the rectangular region surrounding the face 1 specified by the first face region information and the rectangular region surrounding the face 2 specified by the second face region information are selected as a first decoding region. If position information on the face regions (face region information) are not described, the rectangular region (x1, y1), (x2, y2), (x3, y3), and (x4, y4) surrounding all the regions of the original photographed image file is selected as a first decoding region. Thus, based on the multiple pieces of face region information, the CPU 101 decides multiple first decoding regions in a manner that regions respectively specified by the multiple pieces of face region information is defined as regions on which the first decoding processing is performed.

The region (first decoding region) decided at S605 may be the rectangular region surrounded by (xf1-1, yf1-1), (xf1-2, yf1-2), (xf1-3, yf1-3), and (xf1-4, yf1-4) as in this embodiment. The same effect can be obtained with a region in which the rectangular region is expanded or reduced. Thus, it is needless to say that this embodiment is not limited to a form in which the rectangular region itself including the face region is decoded.

When position information on a face region (face region information) is described by one center coordinate, polygon information, or the like, an arbitrary region centering on the center coordinate may be selected. As a result, the same effect as in this embodiment can be obtained. It is needless to say that this embodiment is not limited to a system in which face region information is described with rectangular coordinate information.

At S606, information indicating positions of the regions decided as the first decoding regions determined at S605 (position information on the first decoding regions) is received. The first decoding unit performs decoding processing to the first decoding region (first decoding processing). Decoded image data generated here is first decoded image data.

According to this embodiment, when coordinate information of two rectangular regions, the rectangular region surrounding the face 1 and the rectangular region surrounding the face 2, is received as the position information on the first decoding regions, decoding processing is firstly performed on the rectangular region surrounding the face 1 to generate the first decoded image data including the face 1.

Next, decoding processing is performed on the rectangular region of the face 2 surrounded by (xf2-1, yf2-1), (xf2-2, yf2-2), (xf2-3, yf2-3), and (xf2-4, yf2-4) to generate a second decoded image data including the face 2.

Meanwhile, when coordinate information of the rectangular region (x1, y1), (x2, y2), (x3, y3), and (x4, y4) is received, since the first decoding region is all the regions of the original photographed image file, all the regions are decoded.

At S607, when the coordinate information of the two rectangular regions (position information on the two rectangular regions: the rectangular region surrounding the face 1; and the rectangular region surrounding the face 2), is received and decoding processing is performed on the two rectangular regions at S606, two pieces of first decoded image data are stored in the memory. Specifically, two pieces of first decoded image data, i.e., the first decoded image data including the face 1 and the first decoded image data including the face 2, are saved in the PC memory region of the RAM 103. Meanwhile, when all the regions of the original photographed image file are decoded at S606, the first decoded image data of all the regions of the original photographed image file is saved in the PC memory region of the RAM 103.

At S608, a determination is made as to whether or not the face information flag turns ON at S603. If the face information flag is ON, the processing goes to S609, while if OFF, the processing goes to S612.

At S609, a determination is made as to whether to perform processing giving priority to speed, or to perform processing giving priority to accuracy. If the priority is given to speed, the processing goes to S610, while if the priority is given to accuracy, the processing goes to S615. For the determination here, a screen for selecting whether the priority given to speed or the priority given to accuracy is displayed on the monitor 113. A user may arbitrarily select either one on the computer 100 by using the pointing device 106 or the keyboard 107. In this case, the CPU 101 decides whether the priority given to speed or the priority given to accuracy in accordance with the input by the user. Further, a determination may be automatically made in accordance with the necessary processing speed, when the printing speed of an output printing device, such as a printer, is fast, or other cases. In this case, the CPU 101 acquires specification information of the above-described printer or the like, and decides whether the priority given to speed or the priority given to accuracy based on the information.

At S610, the first decoded image data including the face 1 and the first decoded image data including the face 2 saved in the PC memory region of the RAM 103 are reduced.

At S611, the reduced first decoded image data including the face 1 and the reduced first decoded image data including the face 2 are unified into one image.

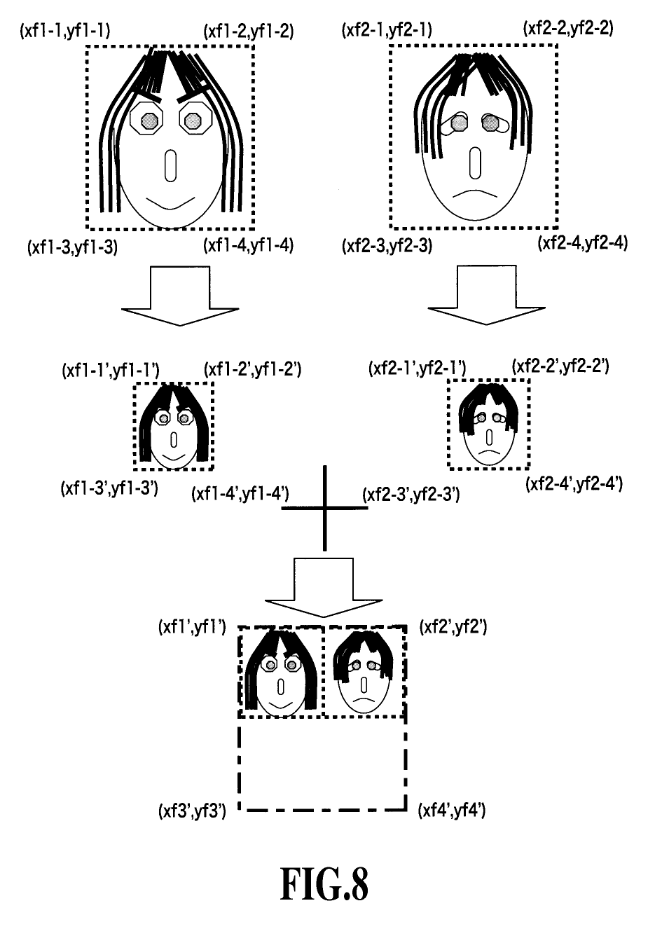

FIG. 8 shows a schematic diagram of reducing and unifying the images at S610 and S611.

At S610, reduction processing is performed on the two pieces of first decoded image data, i.e., the first decoded image data including the face 1 and the first decoded image data including the face 2 saved in the PC memory region of the RAM 103 at S607. According to this embodiment, reduction processing is performed on each of the lengths of four sides of the rectangular region by a demagnification ratio of 1/2.

In coordinates of the first decoded image data after reduction, coordinates of a rectangular region surrounding the face 1 are set as (xf1-1′, yf1-1′), (xf1-2′, yf1-2′), (xf1-3′, yf1-3′), and (xf1-4′, yf1-4′). Coordinates of a rectangular region surrounding the face 2 are set as (xf2-1′, yf2-1′), (xf2-2′, yf2-2′), (xf2-3′, yf2-3′), and (xf2-4′, yf2-4′). For example, for reduction of the face 1, the length of the side which is connected with (xf1-1′, yf1-1′) and (xf1-2′, yf1-2′) has a half length of the length of the side which is connected with (xf1-1, yf1-1) and (xf1-2, yf1-2) before reduction. Further, the number of pixels after reduction becomes 1/4 of that before reduction.

Next, the reduced first decoded image data including the face 1 and the reduced first decoded image data including the face 2 are unified. That is, images are unified so as to overlap each pair of apexes, (xf1-2′, yf1-2′) and (xf2-1′, yf2-1′), and (xf1-4′, yf1-4′) and (xf2-3′, yf2-3′). The unified image data is saved in the PC memory region of the RAM 103 as first decoded image data including the face 1 and the face 2 surrounded by (xf1′, yf1′), (xf2′, yf2′), (xf3′, yf3′), and (xf4′, yf4′).

In this embodiment, described is a case where two face regions are included in one piece of image data. However, it is needless to say that the same effect also can be obtained with a case where three or more face regions are included by performing the same processing as the case where two face regions are included.

Since S612 and S613 are the same as S309 and S310 in the first embodiment, the detailed explanation is omitted here.

At S614, information on the face regions detected at S613 is received, and two pieces of information on the rectangular region including the face region are extracted as coordinate information of eight points. In this embodiment, coordinate information is extracted: the face 1 is extracted as (xf1-1, yf1-1), (xf1-2, yf1-2), (xf1-3, yf1-3), and (xf1-4, yf1-4); and the face 2 is extracted as (xf2-1, yf2-1), (xf2-2, yf2-2), (xf2-3, yf2-3), and (xf2-4, yf2-4). The above-described (xf1-1, yf1-1), (xf1-2, yf1-2), (xf1-3, yf1-3), and (xf1-4, yf1-4) serves as the first face region information. Further, the above-described (xf2-1, yf2-1), (xf2-2, yf2-2), (xf2-3, yf2-3), and (xf2-4, yf2-4) serves as the second face region information.

Considering influence on image quality after correction, this embodiment describes a form in which correction processing is performed on the image data before reduction even when the red-eye region detection is performed on the reduced data. Therefore, for extracting a red-eye region, the coordinates converted into coordinates in the first decoded image data before reduction are used.

At S615, detection processing of a red-eye region is performed on the first decoded image data saved in the PC memory region of the RAM 103. If face region information is stored in the original photographed image file, received are either one of the following: the first decoded image data including the face 1 and the face 2 generated at S611; and both of the first decoded image data including the face 1 and the first decoded image data including the face 2. Then, red-eye region detection is performed.

If face region information is not stored in the original photographed image file, decoding processing is performed on all the regions of the image. Subsequently, the rectangular region information including the face 1 (first face region information) obtained at S614 is received as (xf1-1, yf1-1), (xf1-2, yf1-2), (xf1-3, yf1-3), and (xf1-4, yf1-4) for the generated decoded image data. The rectangular region information including the face 2 (second face region information) is received as (xf2-1, yf2-1), (xf2-2, yf2-2), (xf2-3, yf2-3), and (xf2-4, yf2-4) for the generated decoded image data, and red-eye region detection processing is performed.

At S616, position information on the red-eye regions detected at S615 (specific part position information) is extracted as center coordinates of the red-eye regions (xr1-1, yr1-1), (xr1-2, yr1-2), (xr2-1, yr2-1), and (xr2-2, yr2-2). Considering influence on image quality after correction, this embodiment describes a form in which correction processing is performed on the image data before reduction even when the red-eye region detection is performed on the reduced data. Therefore, for extracting a red-eye region, the coordinates converted into coordinates in the first decoded image data before reduction are used.

Since S617, S618, and S619 are the same as S314, S315, and S316 in the first embodiment, the detailed explanation is omitted here.

Thus, in this embodiment, the steps of S609, S610, and S611 are added to the first embodiment so that image processing can be selectively performed on one image file or one pieces of image data in which multiple pieces of face region information are present.

At this time, if priority is given to speed, multiple pieces of decoded image data are reduced and unified to generate one piece of decoded image data, and red-eye region detection is performed. Accordingly, the further high speed effect can be obtained, while preventing deterioration of the accuracy. If priority is given to accuracy, red-eye region detection is performed on multiple pieces of decoded image data without reduction, as with the first embodiment. With such a method, the further high speed effect can be obtained, as well as the same effect as the first embodiment can be obtained.

According to this embodiment, the two pieces of the first decoded image data including the face region are reduced, and then are unified to convert into one image at S610 and S611. However, it is the same as the above that the order of S610 and S611 is reversed, that is, the two pieces of the first decoded image data are unified to generate one image, and then the one image is reduced. Thus, it is needless to say that this embodiment is not limited to the order of S610 and S611.

In this embodiment, described is an embodiment in which if two face regions are present in one piece of image data, two rectangular regions, that is, the rectangular region including the face 1 and the rectangular region including the face 2, are decoded. However, it is needless to say that the same effect can be obtained in a case where a rectangular region including both the face 1 and the face 2 is selected.

The details of the case will be described by using FIG. 7. When a first decoding region is determined at S605, a rectangular region surrounded by four points of (xf1-1, yf1-1), (xf2-2, yf2-2), (xf1-3, yf1-3), and (xf2-4, yf2-4) is selected. As a result, the rectangular region including both the face 1 and the face 2 can be selected as the first decoding region. Therefore, although a region to be decoded increases as compared with this embodiment mentioned above, the same effect can be obtained by reducing the processing steps of S609, S610, and S611.

Even if the case is compared with the conventional method, effects of increasing the accuracy and speed can be obtained. Thus, it is needless to say that the case is within the range of the present invention.

### Third Embodiment

Next, an embodiment in a case where the vertical direction of a face region in image data, such as photographed image data which becomes origin of a photograph, is not in agreement with the vertical direction of the image data, for example, will be described.

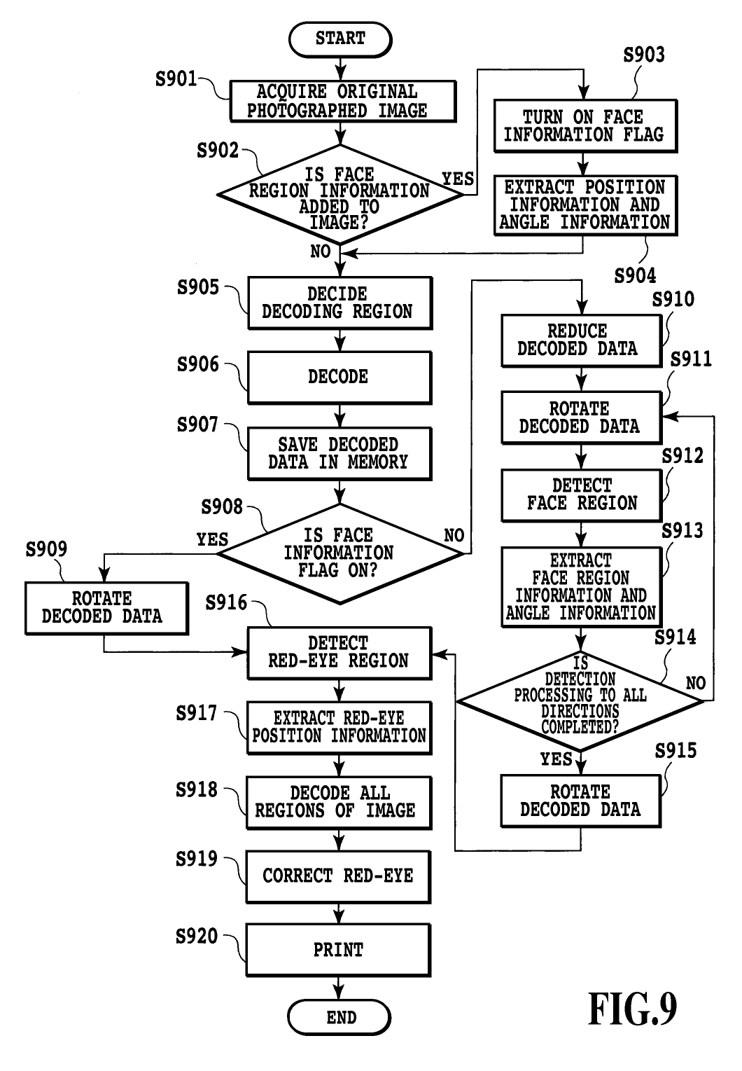

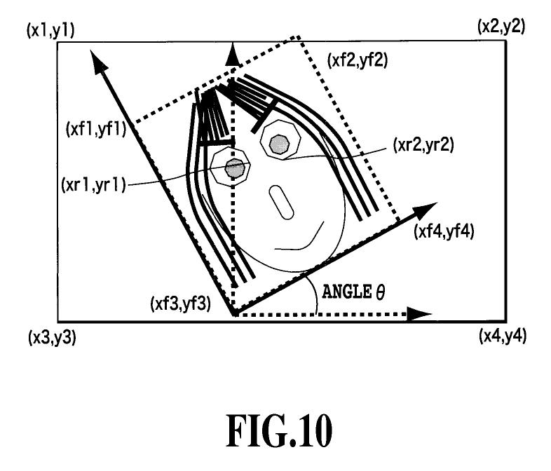

FIG. 9 is a processing flow chart showing details of detection processing of a red-eye included in a skewed face region in this embodiment. Hereafter, the details of the processing are described based on FIG. 9. The processing is controlled as follows: the CPU 101 reads out a program to perform processing shown in FIG. 9, stored in the ROM 102 or the storage device 105, and executes the program. Further, FIG. 10 shows a relation among photographed image data, face region information, and an angle according to this embodiment.

The forms as shown in FIG. 1 and FIG. 2 in the first embodiment can also be applied here to a block diagram showing an example of a configuration of a computer (image processing apparatus) which performs image processing and a flow chart of overall processing of red-eye correction processing for an image file and printing of an image file, respectively. The detailed explanation is omitted here.

Since S901, S902, and S903 are the same as S301, S302, and S303 in the first embodiment, the detailed explanation is omitted here.

At S904, position information of face region information in the original photographed image file and angle information which shows the skew of a face region to the original photographed image data are extracted. According to this embodiment, as shown in FIG. 10, face region information on four points is set to (xf1, yf1) (xf2, yf2), (xf3, yf3), and (xf4, yf4). Further, information on four ends of photographed image data stored in the original photographed image file is set as (x1, y1), (x2, y2), (x3, y3), and (x4, y4). The face region information and the information on four ends of photographed image data are used to obtain an angle θ and angle information is acquired.

Although an angle θ is obtained by regarding the counter clockwise direction as the plus direction in this embodiment, it is needless to say that an effect of the present invention can be obtained also in a form which obtains an angle θ by regarding the clockwise direction as the plus direction.

Since S905, S906, and S907 are the same as S305, S306, and S307 in the first embodiment, the detailed explanation is omitted here.

At S908, a determination is made as to whether or not the face information flag turns ON at S903. If the face information flag is ON, the processing goes to S909, while if OFF, the processing goes to S910.

At S909, based on the above-described angle information thus acquired showing the angle θ, the first decoded image data saved in the PC memory of the RAM 103 is rotated in the clockwise direction by the angle obtained at S904 so as to correct the skew of the angle θ. Subsequently, the first decoded image data thus rotated in which the skew of face region is equivalent to the perpendicular direction of the photographed image data is saved in the PC memory of the RAM 103.

Although a form which allows the image data to be rotated in all angles in this embodiment, for example, the same effect can be obtained with a form which allows the image data to be rotated only in a certain angle direction. Thus, it is needless to say that this embodiment is not limited to a system which allows the image data to be rotated in all directions.

Since S910 is the same as S309 in the first embodiment, the detailed explanation is omitted here.

At S911, the image data reduced at S910 is rotated. Rotating processing is not performed at first try, and the processing goes to S912.

At S912, face region detection is performed on the image data reduced at S910.

At S913, position information and angle information on the face region detected at S912 is extracted. If a face region is detected, an angle θ obtained, and face region position information of (xf1, yf1) (xf2, yf2), (xf3, yf3), and (xf4, yf4) and angle information are extracted similar to at S904. At S914, a determination is made as to whether or not detection processing of a face region is performed on all directions of the image. If detection processing to all directions is completed, the processing goes to S915, while if not completed, the processing returns to S911, and rotation processing is performed on the image data reduced at S910 by 90 degrees counter clockwise. Subsequently, S912, S913, and S914 are repeated.

In this manner, after the image is rotated 90 degrees for each time and the rotation processing is performed up to 270 degrees, the processing goes to S915. Thus, face region detection processing is performed on the image rotated in all directions.

Although rotation processing is performed every 90 degrees in this embodiment, it is needless to say that an effect of the present invention can be obtained with a form in which the rotation angle differs, such as 45 degrees and 180 degrees.

Although rotation processing of image data is performed in the counter clockwise direction in this embodiment, it is needless to say that an effect of the present invention can be obtained with a form in which rotation processing is performed in the clockwise direction.

Although a form in which a face region is detected only in a certain rotation angle is described in this embodiment, it is needless to say that an effect of the present invention can be obtained by adding a step of deleting the overlapping and same face region information when face regions are detected in multiple rotation angles.

In order to perform face region detection in all directions, three steps of S911, S912, and S913 are repeated. A method of performing face detection processing while changing the rotation angle of the reduced image data is general. Face detection processing is performed by using the same method in this embodiment. Although a form in which face region detection is performed on all directions in this embodiment, the same effect as the present invention can be obtained with a form which detects a face region by limiting the skew of the face region to a certain angle direction, for example. Thus, it is needless to say that this embodiment is not limited to a system which detects a face region in all directions.

At S915, rotation processing is performed on the first decoded image data saved in the PC memory of the RAM 103 by an angle at which the face region is detected. The first decoded image data is rotated clockwise so as to correct the skew of the angle θ obtained at S913. Subsequently, the first decoded image data thus rotated in which the skew of face region is equivalent to the perpendicular direction of the photographed image data is saved in the PC memory of the RAM 103.

At S916, a red-eye region is detected to the first decoded image data thus rotated saved in the PC memory of the RAM 103. If face region information is not stored in the photographed image file, red-eye region detection is performed based on coordinate information of (xf1, yf1) (xf2, yf2), (xf3, yf3), and (xf4, yf4) extracted at S913.

At S917, position information on the red-eye region detected at S916 is extracted as center coordinates of the red-eyes (xr1, yr1) and (xr2, yr2). Considering influence on image quality after correction, this embodiment describes a form in which correction processing is performed on the image data before reduction even when the red-eye region detection is performed on the reduced data. Therefore, for extracting a red-eye region, the coordinates converted into coordinates in the first decoded image data before reduction are used.

Since S918, S919, and S920 are the same as S314, S315, and S316 in the first embodiment. The detailed explanation is omitted here.

Thus, an orientation of a face region in the vertical direction can always be aligned in a certain direction by adding the flow of S909 to the first embodiment. As a result, detection processing and correction processing can be performed only to the certain direction regardless of taking the direction of eyes into consideration at the time of red-eye region detection. Thus, the effects of further increasing the accuracy and speed can be obtained, in addition to the effect of the first embodiment, in specific part detection processing which covers all directions.

According to this embodiment, a skew angle θ of a face region is obtained based on coordinate information of the face region. However, if a skew angle θ is described in Tag information, processing for obtaining a skew angle θ is omitted by using information on the skew angle θ as it is. Thus, an effect of further increasing the speed can be obtained.

The effects of further increasing the accuracy and speed can be obtained by combining the second embodiment and the third embodiment, if multiple skewed face regions are present in the original photographed image file.

### Fourth Embodiment

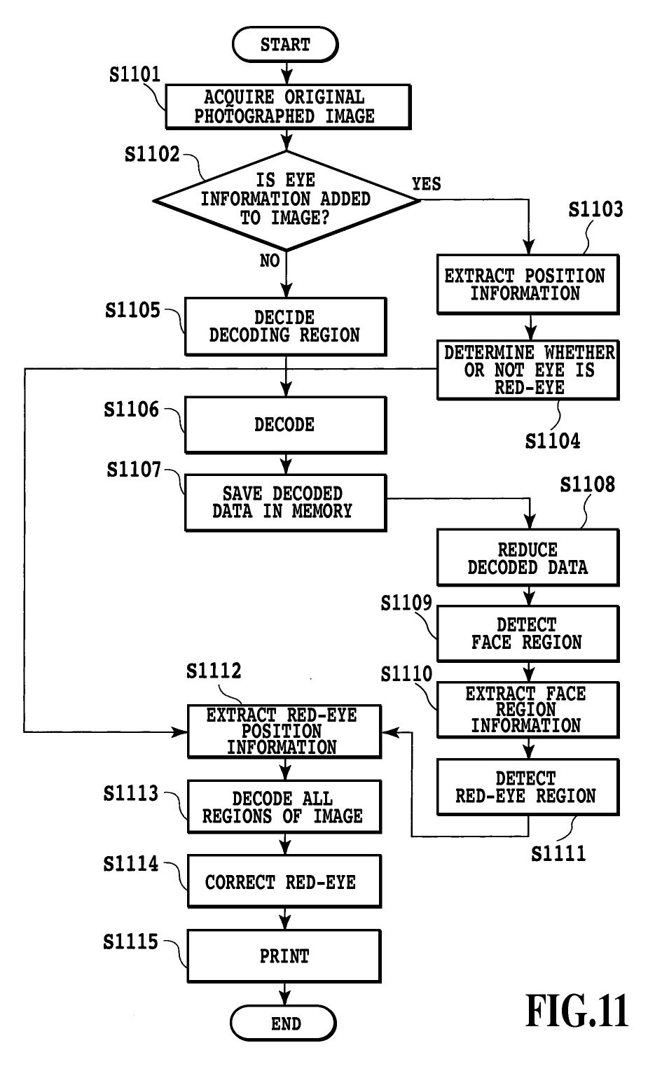

In a fourth embodiment, described is a case where coordinate information of a person region other than the face region such as eyes, a nose, a mouth, and skin is attached to the image data and the image file that the image processing apparatus acquires. FIG. 11 is a processing flow chart showing details of red-eye detection processing on image data in which coordinate information of eye regions (eye region information) according to this embodiment is stored. The processing is controlled as follows: the CPU 101 reads out a program to perform processing shown in FIG. 11, stored in the ROM 102 or the storage device 105, and executes the program. According to this embodiment, each processing will be explained on the assumption that eye regions are described in Exif Tag in a coordinate format of (xe1, ye1) and (xe2, ye2).

The forms as shown in FIG. 1 and FIG. 2 in the first embodiment can also be applied here to a block diagram showing an example of a configuration of a computer (image processing apparatus) which performs image processing and a flow chart of overall processing of red-eye correction processing and printing of an image file, respectively. The detailed explanation is omitted here.

Since an embodiment of the case where eye region information is not described is the same as the one in the first embodiment, the detailed explanation is omitted in this embodiment. Specifically, S1105 to S1111 are the same as S305 to S307 and S309 to S312. Since S1101 is the same as S301 in the first embodiment, the detailed explanation is omitted here.

At S1102, a determination is made as to whether or not eye region information is stored in Exif Tag in the original photographed image file acquired at S1101. According to this embodiment, if a determination is made that eye information is stored, the processing goes to S1103, while if a determination is made that eye information is not stored, the processing goes to S1105.

At S1103, coordinate information (eye region information) of (xe1, ye1) and (xe2, ye2), which are position information on eye regions added to the original photographed image file, is extracted.

At S1104, a determination is made as to whether or not the eye regions are red-eyes based on the extracted (xe1, ye1) and (xe2, ye2) at S1103. That is, the CPU 101 decodes the eye regions or regions obtained by expanding the eye regions by a predetermined pixel, based on the eye region information, which is the position information on (xe1, ye1) and (xe2, ye2), and acquires a first decoding region. Subsequently, the CPU 101 determines whether or not the eye regions included in the first decoding region are red-eyes. If a determination is made that the eye regions are red-eye, the CPU 101 passes the eye region information to S1112. This eye region information thus passes becomes specific part position information.

Since the remaining processing is the same as that in the first embodiment, the detailed explanation is omitted here. That is, S1112 to S1115 are the same processing as S313 to S316 in FIG. 3.

In this manner, a determination is made as to whether or not eye region information is included in the image data at S1102, and red-eye detection is performed at S1104. Accordingly, the processing necessary for decoding processing and detection processing is substantially simplified. As a result, the calculation amount of image processing can be reduced, and high-speed specific part detection, correction, and printing can be provided even in an environment with insufficient hard resource.

Further, the image data treated at the time of specific part detection processing is image data in which only eye regions are expanded, not image data in which the whole image data is reduced. Therefore, the further high accuracy detection can be expected compared with the first embodiment. Accordingly, the probability of occurrence of a correction error can be reduced, and desired red-eye correction can be achieved.

As describe above, with the image processing methods according to the first to the fourth embodiments, desired specific part correction processing can sufficiently be performed by using efficiently the similar face detection processing result by other devices, suppressing a loss of image information, and performing specific part detection processing with high accuracy.

Decoding processing is performed by limiting to image data including a face region, so that image data necessary for performing red-eye detection can be used as required. Accordingly, red-eye detection can be performed exactly on a region on which red-eye detection is to be performed. As a result, incorrect detection of a red-eye can be prevented, and desired specific part correction processing can be sufficiently performed.

Treating the similar face detection processing by other devices as pre-processing makes it possible to perform specific part detection processing at high speed.

With a case where the specific part correction processing is incorporated into a printing device which corrects a red-eye and makes prints, performing red-eye region correction processing with high speed and high accuracy makes it possible to perform red-eye correction printing with high speed and high accuracy.

With a case where multiple face regions are present in one photographed image, the further high speed effect can be obtained by reducing and unifying decoded image data, and performing specific part detection and correction.

In addition, since red-eye region detection processing can be performed only to a certain direction by detecting a skew angle of the face region from face region information, specific part detection processing which covers all directions can be performed at high speed.

### Other Embodiment

The present invention can be applied to a system composed of multiple apparatuses (for example, a computer, an interface device, a reader, a printer, or the like), and to a single apparatus (a multifunction product, a printer, a facsimile machine, or the like).

Also within the range of the above-described embodiments is a processing method in which a program executing the configurations of the above-described embodiments so as to implement the functions of the above-described embodiments is stored in a storage medium, and in which the program stored in the storage medium is read out as a code and is executed in a computer. That is, a storage medium which can be read by a computer is also included within the range of examples. The computer program itself, as well as the storage medium in which the above-described computer program is stored, are included in the above-described embodiments.

As a storage medium, for example, a floppy (registered trademark) disk, a hard disk, an optical disc, a magneto-optical disc, a CD-ROM, magnetic tape, a nonvolatile memory card, and a ROM can be used.

The above-described embodiments includes not only the processing executed with a single program stored in the above-described storage medium, but processing which operates on OS in cooperation with functions of other software and expansion boards, and executes operations of the above-described embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-166253, filed Jun. 25, 2008, which is hereby incorporated by reference herein in its entirety.

What is claimed is:

1. An image processing method comprising the steps of:
acquiring image data;
acquiring specific part information about a position of one region, including at least a specific part, of the acquired image data when the specific part information is added to the image data;
determining a decoding region to be decoded based on the acquired specific part information in order to detect the specific part in the image data;
generating first decoded image data by decoding the decoding region in the image data;
acquiring specific part position information about a position of the specific part by detecting the specific part from the generated first decoded image data;
generating second decoded image data by decoding the image data acquired at the acquiring step; and
correcting the specific part of the second decoded image data based on the acquired specific part position information.

2. The image processing method according to claim 1, wherein the specific part is a red-eye.

3. The image processing method according to claim 2, wherein in the correcting step, the red-eye in the image data is corrected.

4. The image processing method according to claim 1, wherein the specific part is at least one part among an eye, a mouth, and a contour.

5. The image processing method according to claim 1, wherein the specific part information is face region information indicating a position of a face region in the image data; and
in the determining step, a region, including at least the specific part, which is a same region as the face region or which is expanded or reduced by predetermined number of pixels of the face region, is determined as the decoding region based on the face region information.

6. The image processing method according to claim 5, further comprising the steps of:
extracting a predetermined angle when the face region is skewed to the image data by the predetermined angle; and
rotating the first decoded image data based on the extracted angle to correct the skew, between the step of generating the first decoded image data and the step of acquiring the specific part position information.

7. The image processing method according to claim 1, wherein
the specific part information is information indicating a position of the specific part; and
in the determining step, a region including at least the specific part is determined as the decoding region, based on the information indicating the position of the specific part.

8. The image processing method according to claim 1, wherein
a plurality of pieces of the specific part information are added to the image data; and
in the determining step, a plurality of decoding regions is determined based on the respective pieces of specific part information.

9. The image processing method according to claim 1, wherein data acquired at the step of acquiring the image data is an image file which stores the image data therein.

10. The image processing method according to claim 9, wherein the image file is a JPEG file.

11. The image processing method according to claim 1, wherein the specific part information is of a format compliant with an Exif format.

12. The image processing method according to claim 1, wherein the specific part information is information acquired by a device different from a device which performs the image processing method.

13. The image processing method according to claim 1, wherein the specific part information is information indicating coordinates of four points of a rectangle.

14. The image processing method according to claim 1, wherein in the determining steps, the same region as a region specified by the specific part information is determined as the decoding region.

15. An image processing apparatus comprising:
unit for acquiring image data;
unit for acquiring specific part information about a position of one region, including at least a specific part, of the acquired image data when the specific part information is added to the image data;
unit for determining a decoding region to be decoded based on the acquired specific part information in order to detect the specific part in the image data;
unit for generating first decoded image data by decoding the decoding region in the image data;
unit for acquiring specific part position information about a position of the specific part by detecting the specific part from the generated first decoded image data;
unit for generating second decoded image data by decoding the image data acquired by the unit for acquiring image data; and
unit for correcting the specific part of the second decoded image data based on the acquired specific part position information.

16. The image processing apparatus according to claim 15, wherein the specific part is a red-eye.

17. The image processing apparatus according to claim 16, wherein the correcting unit corrects the red-eye in the image data.

18. The image processing apparatus according to claim 15, wherein the specific part is at least one part among an eye, a mouth, and a contour.

19. The image processing apparatus according to claim 15, wherein
the specific part information is face region information indicating a position of a face region in the image data; and
the determining unit determines, as the decoding region based on the face region information, a region, including at least the specific part, which is a same region as the face region or which is expanded or reduced by predetermined number of pixels of the face region.

20. A control program which causes a computer to execute an image processing method in an image processing apparatus and which is storable in a computer-readable storage medium, the control program causes the computer to execute the steps of:
acquiring image data;
acquiring specific part information about a position of one region, including at least a specific part, of the acquired image data when the specific part information is added to the image data;
determining a decoding region to be decoded based on the acquired specific part information in order to detect the specific part in the image data;
generating first decoded image data by decoding the decoding region in the image data;
acquiring specific part position information about a position of the specific part by detecting the specific part from the generated first decoded image data;
generating second decoded image data by decoding the image data acquired at the acquiring step; and
correcting the specific part of the second decoded image data based on the acquired specific part position information.

21. A computer-readable storage medium which stores therein a program to cause a computer to execute an image processing method in an image processing apparatus, the program causes the computer to execute the steps of:
acquiring image data;
acquiring specific part information about a position of one region, including at least a specific part, of the acquired image data when the specific part information is added to the image data;
determining a decoding region to be decoded based on the acquired specific part information in order to detect the specific part in the image data;
generating first decoded image data by decoding the decoding region in the image data;
acquiring specific part position information about a position of the specific part by detecting the specific part from the generated first decoded image data;
generating second decoded image data by decoding the image data acquired at the acquiring step; and
correcting the specific part of the second decoded image data based on the acquired specific part position information.
